(19) United States
(12) Patent Application Publication
(10) Pub. No.: US 2025/0306944 A1
(43) Pub. Date: Oct. 2, 2025

(54) VECTOR OPERATION SEQUENCING FOR EXCEPTION HANDLING

(71) Applicant: Akeana, Inc., Santa Clara, CA (US)

(72) Inventors: Abhijit Sil, Dublin, CA (US); Ricardo Ramirez, Sunnyvale, CA (US)

(73) Assignee: Akeana, Inc., Santa Clara, CA (US)

(21) Appl. No.: 19/090,558

(22) Filed: Mar. 26, 2025

Related U.S. Application Data
(60) Provisional application No. 63/570,281, filed on Mar. 27, 2024.
(60) Provisional application No. 63/640,921, filed on May 1, 2024.
(60) Provisional application No. 63/641,045, filed on May 1, 2024.
(60) Provisional application No. 63/653,402, filed on May 30, 2024.
(60) Provisional application No. 63/679,192, filed on Aug. 5, 2024.
(60) Provisional application No. 63/679,685, filed on Aug. 6, 2024.
(60) Provisional application No. 63/687,795, filed on Aug. 28, 2024.
(60) Provisional application No. 63/690,822, filed on Sep. 5, 2024.
(60) Provisional application No. 63/691,351, filed on Sep. 6, 2024.
(60) Provisional application No. 63/699,245, filed on Sep. 26, 2024.
(60) Provisional application No. 63/702,192, filed on Oct. 2, 2024.
(60) Provisional application No. 63/714,529, filed on Oct. 31, 2024.
(60) Provisional application No. 63/719,841, filed on Nov. 13, 2024.
(60) Provisional application No. 63/730,997, filed on Dec. 12, 2024.
(60) Provisional application No. 63/735,937, filed on Dec. 19, 2024.
(60) Provisional application No. 63/745,432, filed on Jan. 15, 2025.
(60) Provisional application No. 63/764,198, filed on Feb. 27, 2025.
(60) Provisional application No. 63/765,094, filed on Feb. 28, 2025.

(51) Int. Cl. G06F 9/38; G06F 9/24; G06F 9/30

(52) U.S. Cl. CPC G06F 9/3861; G06F 9/24; G06F 9/30036; G06F 9/3869

(57) ABSTRACT

Techniques for vector instruction operation are disclosed. A processor core is accessed. The processor core supports vector operations, the processor core includes an execution pipeline, and the execution pipeline is configured to execute micro-operations. A vector operation is issued, in the processor core. The vector operation necessitates a plurality of execution cycles. The vector operation is split into a series of micro-operations. Execution of the series of micro-operations is initiated. An operation exception is received by the processor core. The operation exception is processed. Execution of the series of micro-operations is completed, based on the timing of the operation exception. The splitting, the initiating, and the completing are performed by a micro-operation sequencer within a decode unit of the processor core. The micro-operation sequencer assigns the series of micro-operations, based on a type of the vector operation.

### RELATED APPLICATIONS

This application claims the benefit of U.S. provisional patent applications “Vector Operation Sequencing For Exception Handling” Ser. No. 63/570,281, filed Mar. 27, 2024, “Vector Length Determination For Fault-Only-First Loads With Out-Of-Order Micro-Operations” Ser. No. 63/640,921, filed May 1, 2024, “Circular Queue Management With Nondestructive Speculative Reads” Ser. No. 63/641,045, filed May 1, 2024, “Direct Data Transfer With Cache Line Owner Assignment” Ser. No. 63/653,402, filed May 30, 2024, “Weight-Stationary Matrix Multiply Accelerator With Tightly Coupled L2 Cache” Ser. No. 63/679,192, filed Aug. 5, 2024, “Non-Blocking Vector Instruction Dispatch With Micro-Operations” Ser. No. 63/679,685, filed Aug. 6, 2024, “Atomic Compare And Swap Using Micro-Operations” Ser. No. 63/687,795, filed Aug. 28, 2024, “Atomic Updating Of Page Table Entry Status Bits” Ser. No. 63/690,822, filed Sep. 5, 2024, “Adaptive SOC Routing With Distributed Quality-Of-Service Agents” Ser. No. 63/691,351, filed Sep. 6, 2024, “Communications Protocol Conversion Over A Mesh Interconnect” Ser. No. 63/699,245, filed Sep. 26, 2024, “Non-Blocking Unit Stride Vector Instruction Dispatch With Micro-Operations” Ser. No. 63/702, 192, filed Oct. 2, 2024, “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764, 198, filed Feb. 27, 2025, and “Transformed Activation Function With ISA Extension” Ser. No. 63/765,094, filed Feb. 28, 2025.

Each of the foregoing applications is hereby incorporated by reference in its entirety.

### FIELD OF ART

This application relates generally to instruction execution and more particularly to vector operation sequencing for exception handling.

### BACKGROUND

Processors provide power to many modern electronic devices. Computers, smartphones, appliances, and smart homes all contain at least one processor. Making the processors faster enhances system performance. Specifically, common tasks such as opening apps, loading web pages, etc. are completed more quickly, thus improving user experience and productivity. A fast processor supports multiple tasks simultaneously, enabling efficient handling of tasks such as editing large files or streaming high-definition media. Furthermore, gaming systems benefit significantly from fast processors. Modern video games require substantial processing power to render complex graphics, perform simulations, and enable artificial intelligence. A faster processor provides higher video frame rates, reduces response lag, and enhances the gaming experience. Moreover, AI and machine learning applications require significant computational power. Faster processors optimized for AI workloads accelerate AI training and inference tasks.

The main categories of processors include Complex Instruction Set Computer (CISC) types, and Reduced Instruction Set Computer (RISC) types. In a CISC processor, one instruction may execute several operations. The operations can include memory storage, loading from memory, an arithmetic operation, and so on. In a RISC processor, the instruction sets are smaller than the CISC instruction sets and may be executed in a pipelined manner. Pipeline stages may include fetch, decode, and execute. Each of these pipeline stages may take one clock cycle, and thus, the pipelined operation can allow RISC processors to operate on more than one instruction per clock cycle.

Integrated circuits (ICs) or “chips” such as processors are designed using a Hardware Description Language (HDL). Examples of HDLs include Verilog, VHDL, etc. HDLs support the description of behavioral, register transfer, gate, and switch level logic. This support provides designers the ability to define system levels with varying detail. Behavioral level logic allows for a set of instructions executed sequentially, while register transfer level logic allows for the transfer of data between registers, driven by an explicit clock and gate level logic. An HDL can be used to create text models that describe or express logic circuits. The models can be processed by a synthesis program, followed by a simulation or emulation program to test the logic design. Part of the process can include Register Level Transfer (RTL) abstractions that define the synthesizable data that is fed into a logic synthesis tool, which in turn creates the gate-level abstraction of the design that is used for downstream implementation operations.

The HDL tools enable the design and implementation of processors and other integrated circuits such as System-on-Chip (SoC) integrated circuits. SoC integrated circuits are highly versatile and find applications in a wide range of electronic devices and systems. These integrated circuits are designed to incorporate multiple components and functionalities onto a single chip, making them compact, power-efficient, and cost-effective. Processor performance enables a wide variety of applications, including data processing, virtualization, content creation, and security applications, to name a few. Thus, processor performance continues to be an important factor in the development of new systems and technologies.

### SUMMARY

Extensions such as vector operation extensions can be enabled for a processor architecture such as a RISC-V processor core. By splitting a vector operation into a series of micro-operations, and initiating execution of the series of micro-operations, the vector can begin execution. While a micro-operation within the series of micro-operations is executing, the processor core can experience an exception such as a runtime exception. When the processor core receives an exception, execution of the series of micro-operations can be suspended by saving the last successfully completed micro-operation, based on the operation exception being received. The saving the last successfully completed micro-operation is accomplished using a micro-operation sequencer within the processor core. Having saved the last successfully completed micro-operation, the exception can be processed by an element such as an exception handler. Based on completion of the operation exception, the micro-operation sequencer restarts the series of micro-operations at the first unexecuted micro-operation of the series of micro-operations. Execution of the series of micro-operations is completed, based on the timing of the operation exception. The timing of the operation exception can indicate the last micro-operation that was successfully completed, and thus the next micro-operation to be executed.

Techniques for vector instruction handling are disclosed. A processor core is accessed. The processor core supports vector operations, the processor core includes an execution pipeline, and the execution pipeline is configured to execute micro-operations. A vector operation is issued in the processor core. The vector operation necessitates a plurality of execution cycles. The vector operation is split into a series of micro-operations. Execution of the series of micro-operations is initiated. An operation exception is received by the processor core. The operation exception is processed. Execution of the series of micro-operations is completed, based on the timing of the operation exception. The splitting, the initiating, and the completing are performed by a micro-operation sequencer within a decode unit of the processor core. The micro-operation sequencer assigns the series of micro-operations, based on a type of the vector operation.

A processor-implemented method for instruction execution is disclosed comprising: accessing a processor core, wherein the processor core supports vector operations, wherein the processor core includes an execution pipeline, and wherein the execution pipeline is configured to execute micro-operations; issuing a vector operation, in the processor core, wherein the vector operation necessitates a plurality of execution cycles; splitting the vector operation into a series of micro-operations; initiating execution of the series of micro-operations; receiving, by the processor core, an operation exception; processing the operation exception; and completing execution of the series of micro-operations, based on the timing of the operation exception. In embodiments, the splitting, the initiating, and the completing are performed by a micro-operation sequencer within a decode unit of the processor core. In embodiments, the micro-operation sequencer assigns the series of micro-operations, based on a type of the vector operation. In embodiments, the micro-operation sequencer tracks execution of the series of micro-operations.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for vector operation sequencing for exception handling.

FIG. 2 is a flow diagram for micro-operation sequencer usage.

FIG. 3 illustrates a processor pipeline adapted for vector operations.

FIG. 4 is a pipeline block diagram illustrating exception handling.

FIG. 5 is a block diagram for a multicore processor.

FIG. 6 is a block diagram for a pipeline.

FIG. 7 shows a micro-operation example.

FIG. 8 is a system diagram for vector operation sequencing for exception handling.

### DETAILED DESCRIPTION

The performance of one or more processors in a given device directly impacts the performance and utility of the device. Common processor device applications include mobile and handheld devices, wearable devices, consumer electronics, automotive electronics, edge computing, and Internet of Things (IoT), to name a few. For one class of processors that includes RISC processors, efficient instruction or operation pipelines play a critical role in the overall processor performance and functionality. The operations that utilize the efficient pipelines include vector operations. The vector operations can be split into a series of micro-operations, where the micro-operations can be provided to the pipeline for execution. The efficient operation pipelines allow for the concurrent execution of multiple micro-operations, yielding a higher instruction throughput. By separating the execution of the micro-operations into multiple pipeline stages, each stage can be optimized for a specific task, resulting in faster micro-operation processing. Use of a pipeline, or “pipelining,” reduces the time it takes to execute a series of micro-operations by providing the micro-operations to the pipeline. This technique enables the processor to initiate processing of a next operation before the previous operation has completed. Shortening the execution time of individual operations translates to faster overall program execution. Further, the execution of the series of micro-operations can handle an exception. The exception can include a runtime exception, an illegal operation, a data contention hazard, and so on. The exception can be processed by a processor, and execution of the series of micro-operations can proceed following the last micro-operation that was successfully completed before the exception occurred. The increased processor performance attributable to sequencing of the micro-operations occurs when the vector exploits instruction-level parallelism (ILP). The ILP enables multiple instructions or operations to be in various stages of execution simultaneously. Furthermore, efficient pipelines help maintain a steady flow of operations through the processor, reducing the likelihood of operation stalls or bottlenecks. A smooth operation flow ensures that the processor can consistently operate at its maximum potential.

Techniques for vector operation sequencing for exception handling are disclosed. A vector operation is issued for execution on a processor core. The vector operation can necessitate a plurality of execution cycles, where the execution cycles can include accessing data storage to obtain data associated with the vector operation. The execution cycles can further include cycles required by the vector operation. Further execution cycles can include accessing storage for storing results of the vector operation. The processor core can split the vector operation into a series of micro-operations, where the micro-operations can be provided to an execution pipeline included in the processor core. While the execution pipeline is executing the micro-operations, an operation exception can be received by the processor core. A micro-operation sequencer within a decode unit within the processor core tracks execution of the series of micro-operations. When an operation exception is received, the micro-operation sequencer saves the last successfully completed micro-operation. When processing of the operation exception has been completed, the micro-operation sequencer restarts the series of micro-operations at the first unexecuted micro-operation of the series of micro-operations. Thus, completion of execution of the series of micro-operations can be achieved without having to flush the pipeline upon receiving the operation exception and refill the pipeline after the operation exception has been processed.

Vector operations are common in many instruction set architectures (ISAs). Vector operations can, with a single instruction, require many individual operations to complete the single instruction. For example, vector operations such as scalar multiplication, vector addition, vector dot product, vector cross product, and so on can involve several steps and complex operations to accurately compute the result of the vector operation. One step can include operand preparation. This step can include alignment of one or more vectors. In one or more embodiments, the actual vector operation can be performed using hardware components including, but not limited to, pipelines dedicated to vector operations. In some embodiments, an iterative or algorithmic approach may be used to execute the vector operation. Since vector operations can include arithmetic operations such as addition or multiplication, the result of the vector operation may contain more bits of precision than a numerical format such as a floating-point format allows. The rounding process can be performed to reduce the precision to the specified format (e.g., single-precision or double-precision). Moreover, a vector operation can include overflow and underflow handling. The vector operation result may lead to overflow (result too large to represent) or underflow (result too small to represent) conditions. These exceptional cases need to be detected and handled. In some cases, the result may be represented as infinity or zero, depending on the specific floating-point standard (e.g., the IEEE 754 standard). Further error handling can include NaN (not-a-number) handling, and/or exception handling. In embodiments, NaN is a special floating-point value used to represent the result of certain operations that do not yield a valid numeric value. NaN provides techniques for the processor to signal that a particular operation has produced an undefined or unrepresentable result. NaN serves as a placeholder to indicate that a computation has failed to produce a meaningful numeric value, due to various reasons. The final result of the vector operation can be encoded in the chosen floating-point format, which includes the sign bit, exponent, and mantissa. In embodiments, the exponent bias, which is used to represent both positive and negative exponents, is considered when encoding the exponent.

When an exception occurs, which can comprise a core exception, an execution element exception, an operating system exception, a hardware interrupt, a software interrupt, and so on, a vector operation in process may need to be halted in order to process the exception or interrupt. This often means that the halted operation is unloaded from the processor pipeline and stored for future restarting after the exception is processed. Typically, the entire vector instruction would simply be restarted, but that leads to waste and inefficiency, because the already-completed operations of the vector instruction would be lost. Disclosed concepts enable efficiently handling vector operation restart after an exception to improve processor performance and throughput. In addition to saving power and improving performance, resuming vector load/store execution using vstart can be a functional requirement for certain vector load/store operations, such as for non-segmented index load/store operations. In this case, destination and source locations are allowed to overlap. Thus, due to an exception and restarting from micro-operation uop0, some of the source data will have been changed from the original data.

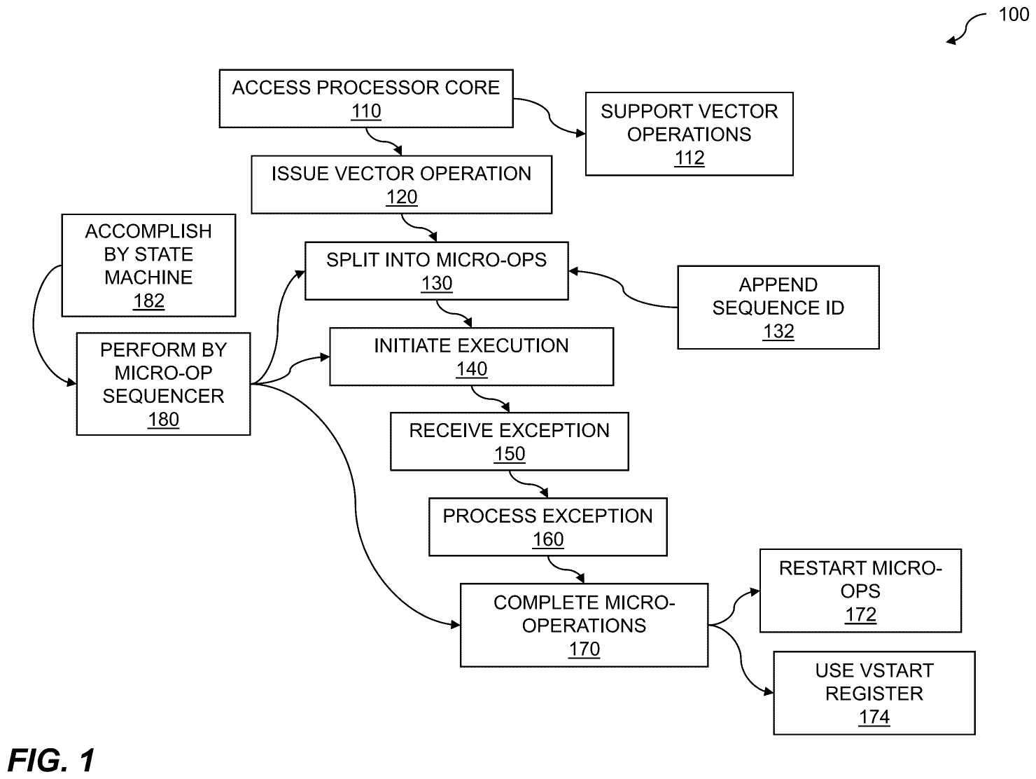

FIG. 1 is a flow diagram for vector operation sequencing for exception handling. The flow 100 includes accessing a processor core 110. The processor core can be included on a multi-processor chip, an application specific integrated circuit (ASIC), a system-on-a-chip (SOC), and so on. The processor core can execute instructions that are part of an instruction set architecture (ISA) such as X86, ARM, and so on. In embodiments, the processor core can include a RISC-V architecture. In the flow 100, the processor core supports vector operations 112. The vector operations can include scalar multiplication, vector addition, determining scalar components of the vector, vector cross product, and so on. In embodiments, a RISC-V architecture can include vector extensions. Various vector extensions can be included in the processor core. In embodiments, the vector extensions can include ELEN, VLEN, SEW, LMUL, VLMAX, VL, and VSTART components. The vector operations can be based on various numerical precisions such as a single-precision floating point, double-precision floating point, etc. The processor core includes an execution pipeline, wherein the execution pipeline is configured to execute micro-operations. Discussed below, the vector operation can be split into micro-operations for execution.

The flow 100 includes issuing a vector operation 120, in the processor core, wherein the vector operation necessitates a plurality of execution cycles. The issuing a vector operation can be based on obtaining the vector operation from storage. The storage from which the vector operation is obtained can include an instruction cache associated with the processor core. The vector operation that is issued can be based on a program counter associated with the processor core. The plurality of execution cycles can be based on architectural cycles associated with the processor core, system clock cycles, processor core clock cycles, etc. In embodiments, the vector operation can include a vector indexed load/store instruction.

The flow 100 includes splitting the vector operation 130 into a series of micro-operations. A vector operation can be split into two or more micro-operations. The number of micro-operations can include a power of two number or a non-power of two number. The splitting can be accomplished using a micro-operation sequencer within a decode unit of the processor core. The micro-operation sequencer is described below. The splitting by the micro-sequencer can be accompanied by a variety of techniques that can keep track of the micro-operations. In the flow 100, the micro-operation sequencer appends a sequence ID 132 to each of the series of micro-operations. The sequence ID can uniquely identify a series of micro-operations associated with a vector operation. In embodiments, the sequence ID can enable tracking operational flow among pipeline stages of the execution pipeline of the processor core.

The flow 100 includes initiating execution 140 of the series of micro-operations. The initiating execution can include submitting the series of micro-operations to the processor pipeline, where the processor pipeline can include a pipeline adapted for vector operations. The execution of the micro-operations within the series of micro-operations can be accomplished based on one or more steps of a program counter associated with the processor core. In embodiments, the series of micro-operations can occur within a single program counter step. The number of program counter steps associated with the micro-operations can depend on the micro-operations that are being executed. In other embodiments, the series of micro-operations occurs over a plurality of processor core clock cycles.

While the series of micro-operations is executing, an operation exception can occur. The operation exception can be based on an illegal operation, a memory access hazard, a higher priority operation, and so on. The flow 100 includes receiving 150, by the processor core, an operation exception. An operation exception can occur at any point during the executing of the micro-operations. In embodiments, the operation exception can occur on a program counter basis. Various actions can be taken based on receiving the operation exception. In embodiments, the micro-operation sequencer can save the last successfully completed micro-operation, based on the operation exception being received. By saving the last successfully completed micro-operation with the series of micro-operations, execution of the series of micro-operations can resume after the operation exception is handled.

The flow 100 includes processing 160 the operation exception. Various techniques can be used for processing the operation exception. In embodiments, the operation exception handling can be accomplished by an exception handler associated with the processor core. The processing the operation can include storing a value, where the value can indicate where in the series of micro-operations execution should resume. In embodiments, the operation exception can initiate writing a restart value to an architectural register within a decoder block of the processor core. The architectural register can include a general-purpose register, a special architectural register, and so on. In embodiments, the architectural register within the decoder block of the processor core can include a VSTART architectural register.

The flow 100 includes completing execution 170 of the series of micro-operations, based on the timing of the operation exception. The timing of the operation exception can indicate where in the series of micro-operations execution was interrupted by the operation exception. In the flow 100, the completing includes restarting the micro-operations 172, based on retirement of a successfully completed micro-operation within the series of micro-operations. One or more micro-operations can complete before an operation exception occurs. In embodiments, the retirement of a successfully completed micro-operation within the series of micro-operations can occur prior to the operation exception. If an exception occurs during execution of a micro-operation, then the micro-operation that did not complete will need to be continued. In the flow 100, completing execution is based on using the VSTART architectural register 174. The VSTART architectural register can include a value indicating the first micro-operation following the last micro-operation that was successfully completed or “retired” before the operation exception was received.

In the flow 100, the splitting, the initiating, and the completing are performed by a micro-operation sequencer 180 within a decode unit of the processor core. The micro-operation sequencer can direct the series of micro-operations to a pipeline within a processor core for execution. In embodiments, the micro-operation sequencer assigns the series of micro-operations, based on a type of the vector operation. The assignment can be based on processor core capabilities, availability, and the like. The micro-operation can initiate execution of the series of micro-operations. In embodiments, the micro-operation sequencer can track execution of the series of micro-operations. Discussed previously and below, the tracking can be based on a sequence ID appended to each of the series. The tracking can enable restarting execution of the series of micro-operations after an operation execution has been processed. In embodiments, the micro-operation sequencer can restart the series of micro-operations at a first unexecuted micro-operation of the series of micro-operations, based on completion of the operation exception. The micro-operation sequencer operation can be accomplished using a variety of techniques. In embodiments, the splitting, the initiating, and the completing are accomplished by an independent state machine 182 within the processor core.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

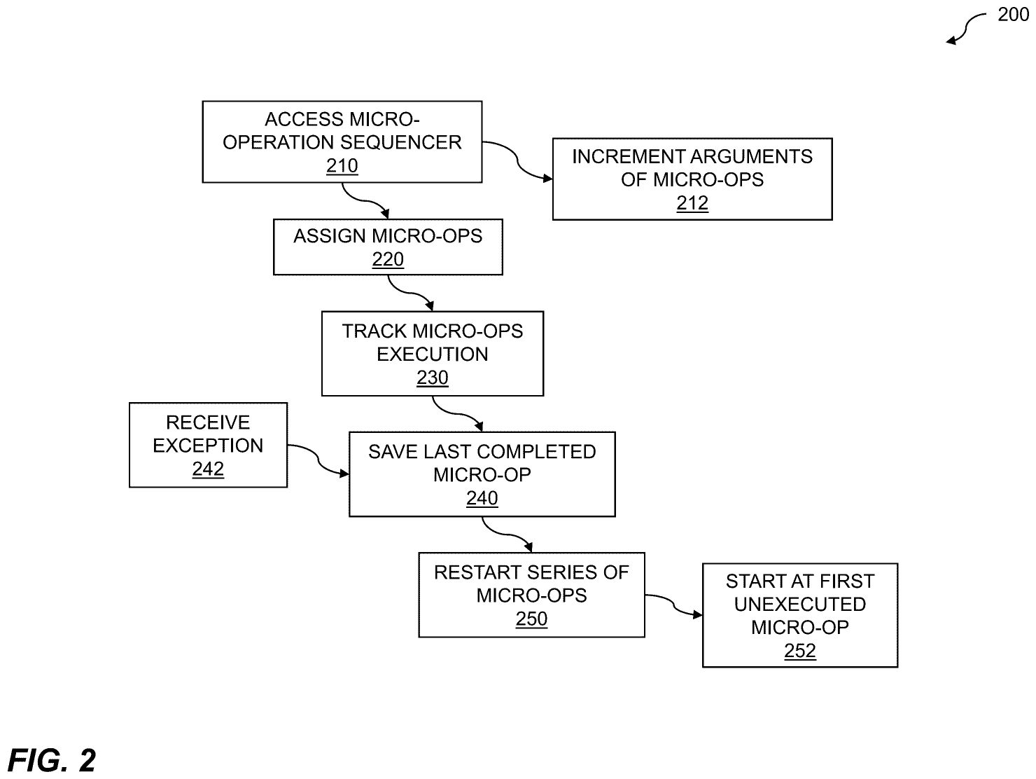

FIG. 2 is a flow diagram micro-operation sequencer usage. The flow 200 can include accessing a micro-operation sequencer 210. The micro-operation sequencer can be located within a decode unit of a processor core. The micro-operation sequencer can be used to perform splitting a vector operation into a series of micro-operations, initiating execution of the micro-operations, and completing execution of the micro-operations after processing an operation exception received by the processor core. In the flow 200, the micro-operation sequencer increments 212 source and destination arguments for each of the micro-operations within the series of micro-operations. The incrementing source and destination arguments can ensure that correct data is loaded for each micro-operation and that resulting data is stored for each micro-operation. In a usage example, the source argument can include a source register within the processor core and the destination argument can include a destination register within the processor core. The source register and the destination register can include architectural registers within the processor core.

In the flow 200, the micro-operation sequencer assigns 220 the series of micro-operations, based on a type of the vector operation. The assigning can include assigning the series of micro-operations to a processor core. The assigning can include assigning the micro-operations to a pipeline within the processor core, where the pipeline is adapted for vector operations. In the flow 200, the micro-operation sequencer tracks execution 230 of the series of micro-operations. The tracking execution can include determining which micro-operations have completed, which micro-operations have yet to be completed, and so on. The tracking can be accomplished using a variety of techniques. In embodiments, the micro-operation sequencer can append a sequence ID to each of the series of micro-operations. The ID can include a code, a value, a key, one or more characters, and so on. The sequence ID can be keyed to a given micro-operation, referenced from previous micro-operations, etc. The ID can be examined by the processor core. In embodiments, the sequence ID can enable tracking operational flow among pipeline stages of the execution pipeline of the processor core.

In the flow 200, the micro-operation sequencer saves 240 the last successfully completed micro-operation, based on the operation exception being received. Completion of a micro-operation can include transiting, by the micro-operation, each stage of the processor pipeline adapted for vector operations. The saving can be trigged by an event such as an operation exception. The flow 200 includes receiving, by the processor core, an operation exception 242. The operation exception can include a runtime error, detection of a memory access hazard, and so on. In embodiments, the timing of the operation exception can occur at an indeterminate point within the execution of the series of micro-operations. The operation exception can be handled by the processor core, an element within the processor core, and the like. In embodiments, the exception can be handled by an exception handler associated with the processor core. The exception handler can include an element within the processor core, an element accessible to the processor core, etc.

In the flow 200, the micro-operation sequencer restarts 250 the series of micro-operations, based on completion of the operation exception. The restarting can be based on the sequence ID that was appended to the first unexecuted micro-operation by the micro-operation sequencer. In the flow 200, the restarting by the micro-operation sequencer occurs at the first unexecuted micro-operation 252 of the series of micro-operations. Execution of the remaining unexecuted micro-operations can follow execution of the first unexecuted micro-operation.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

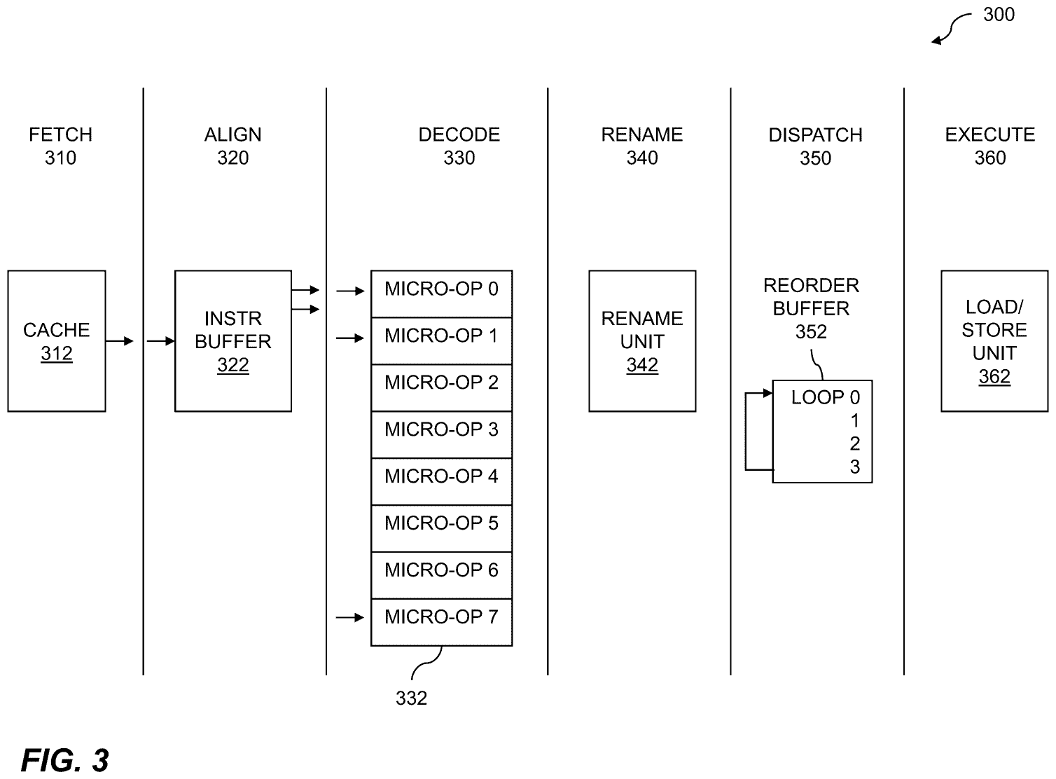

FIG. 3 illustrates a processor pipeline adapted for vector operations. A pipeline can be associated with a processor core. The processor core can be based on a variety of design approaches and processor architectures such as a RISC-V processor. The pipeline can be adapted for vector operations. The vector operations can be split into micro-operations in order to handle exceptions such as runtime exceptions. The pipeline described herein enables vector operation sequencing for exception handling. A processor core is accessed, wherein the processor core supports vector operations, wherein the processor core includes an execution pipeline, and wherein the execution pipeline is configured to execute micro-operations. A vector operation is issued, in the processor core, wherein the vector operation necessitates a plurality of execution cycles. The vector operation is split into a series of micro-operations. Execution of the series of micro-operations is initiated. An operation exception is received by the processor core. The operation exception is processed. Execution of the series of micro-operations is completed, based on the timing of the operation exception.

A pipeline adapted for vector operations is shown. The pipeline comprises a plurality of stages that can, when the pipeline is filled, be executing substantially simultaneously. The use of the pipeline can significantly enhance processing of operations such as vector operations. The pipeline 300 can include a fetch element 310. The fetch element can obtain data from one or more storage elements. The storage elements can include a cache 312. The cache can include a local cache, a shared cache, and so on. The cache can include a multilevel cache technique, where the multiple levels of the cache can include one or more of a level 1 (L1) cache, a level 2 (L2) cache, a level 3 (L3) cache, and the like. The pipeline 300 can include an alignment element 320. The alignment register can align a vector operation to a boundary or edge such as a byte or word edge. The aligning enables decoding the vector operation (discussed below). The alignment element can include an instruction buffer 322. The instruction buffer can contain one or more aligned vector operations. The aligning can be based on one or more parameters associated with the vector operation. The one or more parameters can include an clement width (ELEN), a vector register width (VLEN), a selected element width (SEW), a vector register group multiplier (LMUL), maximum operable elements (VLMAX), a vector length (VL), a starting element (VSTART), etc. The pipeline can include a decode element 330. The decode element can decode an operation such as a vector operation into a series of micro-operations. A plurality of vector operations is shown 332. While eight micro-operations are shown, such as micro-op 0, micro-op 1, micro-op 2, micro-op 3, micro-op 4, micro-op 5, micro-op 6, and micro-op 7, other numbers of micro-operations can result from the decoding. In embodiments, the number of micro-operations can include a power of two.

The pipeline 300 can include a renaming stage 340. The renaming stage can include a rename unit 342. The rename unit takes logical resource names and maps them into available physical resource names. The pipeline 300 can include a dispatch stage 350. The dispatch stage can dispatch one or more micro-operations, such as the micro-operations generated by the decode stage, to one or more processor cores. The dispatch stage can include a reorder buffer 352. The reorder buffer can keep track of which micro-operation is executing, which micro-operations have completed, which micro-operations have yet to be executed, etc. The reorder buffer can be used to track the execution of the micro-operations if an exception occurs. An exception can occur due to an illegal operation, missing or delayed data, storage access contention, and so on. The pipeline can include an execution stage 360. The execution stage can execute the one or more micro-operations that were generated from the vector operation. The execution stage can include a load/store unit 362. The load/store unit can load data required by a micro-operation and can store data generated by a micro-operation.

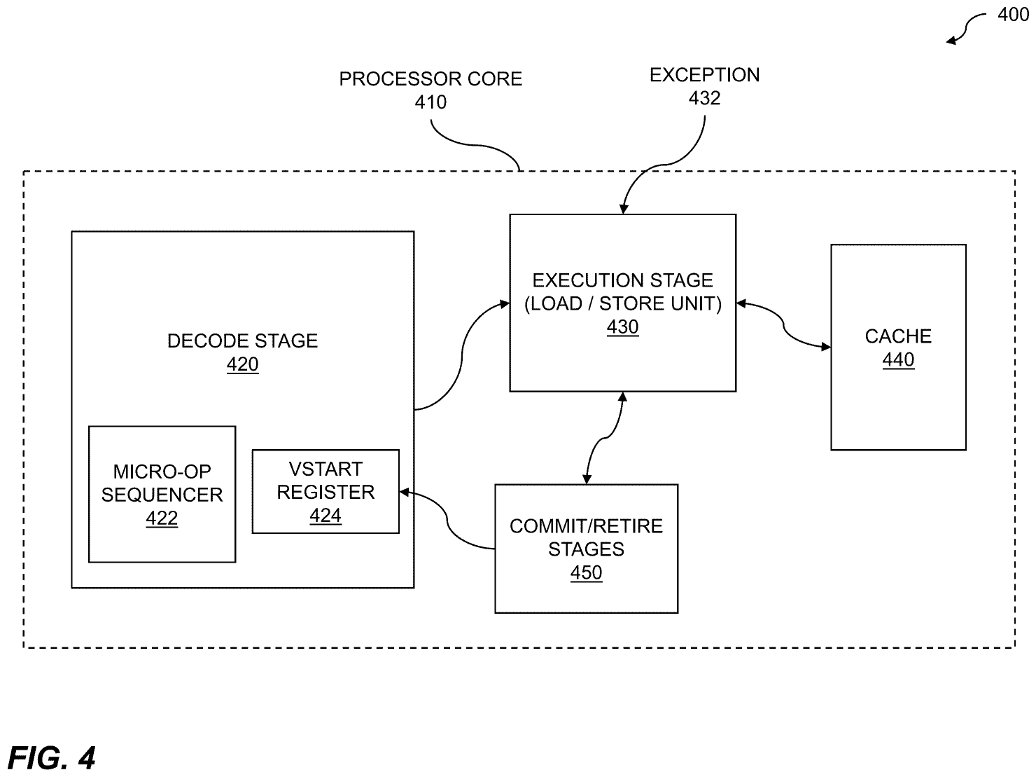

FIG. 4 is a pipeline block diagram illustrating exception handling. An exception can occur while a series of micro-operations associated with a vector operation is executing. The exception can occur due to a runtime error, a storage access contention issue or hazard, a higher priority operation requiring execution, and so on. The exception handling is supported by vector operation sequencing. A processor core is accessed, wherein the processor core supports vector operations, wherein the processor core includes an execution pipeline, and wherein the execution pipeline is configured to execute micro-operations. A vector operation is issued, in the processor core, wherein the vector operation necessitates a plurality of execution cycles. The vector operation is split into a series of micro-operations. Execution of the series of micro-operations is initiated. An operation exception is received by the processor core. The operation exception is processed. Execution of the series of micro-operations is completed, based on the timing of the operation exception.

The block diagram 400 includes a processor core 410. The processor core can be accessed for processing an operation such as a vector operation. The processor core can include one or more elements that support vector operations. In embodiments, the processor core can include an execution pipeline, wherein the execution pipeline is configured to execute micro-operations. The micro-operations can be generated from a vector operation. The processor core can include a decode stage 420. The decode stage can accomplish one or more tasks associated with executing a vector operation. The tasks can include splitting the vector operation into a series of micro-operations, initiating execution of the series of micro-operations, completing execution of the series of micro-operations, and so on. In embodiments, the splitting, the initiating, and the completing can be accomplished by an independent state machine within the processor core. The tasks can further include receiving and processing an operation exception. In embodiments, the splitting, the initiating, and the completing can be performed by a micro-operation sequencer 422 within a decode unit of the processor core. The micro-operation sequencer can sequence the micro-operations and accomplish other tasks associated with the micro-operations. In embodiments, the micro-operation sequencer can track execution of the series of micro-operations. The tracking can include noting which micro-operations have completed, which need to be executed, and so on. An exception can occur. In embodiments, the micro-operation sequencer can save the last successfully completed micro-operation, based on the operation exception being received. The operation exception can be processed. In embodiments, the micro-operation sequencer can restart the series of micro-operations at the first unexecuted micro-operation of the series of micro-operations, based on completion of the operation exception.

In embodiments, the micro-operation sequencer can assign the series of micro-operations, based on a type of the vector operation. The block diagram 400 includes an execution stage 430. The execution stage can accomplish load operations and store operations. The load and store operations can load data to be operated on by a micro-operation, store data produced by a micro-operation, and so on. The load and store operation can access storage. The storage can include local storage, shared local storage, shared system storage, and so on. In embodiments, the processor core can receive an operation exception 432. The operation exception can result from a runtime error, data being unavailable, and so on. The operation exception can be processed prior to completing execution of the series of micro-operations. The block diagram 400 can include cache storage 440. The cache storage can include a first level (L1) cache, a multi-level cache, and the like.

The block diagram 400 can include commit and retire stages 450. The commit stage can commit a micro-operation to execution at the execution stage of the pipeline. Upon completion of the execution of the micro-operation, the micro-operation can be retired. In embodiments, the completing can include restarting the micro-operations, based on retirement of a successfully completed micro-operation within the series of micro-operations. Recall that an exception can occur during execution of any micro-operation within the series of micro-operations. If a micro-operation has completed, then the micro-operation can be retired. If the micro-operation has not completed, then the interrupted micro-operation can be restarted. In embodiments, the retirement of a successfully completed micro-operation within the series of micro-operations can occur prior to the operation exception. Various techniques can be used for handling an exception. In embodiments, the operation exception can initiate writing a restart value to an architectural register within a decoder block of the processor core. Various architectural registers can be used for storing the restart value. In embodiments, the architectural register 424 within the decoder block of the processor core can include a VSTART architectural register.

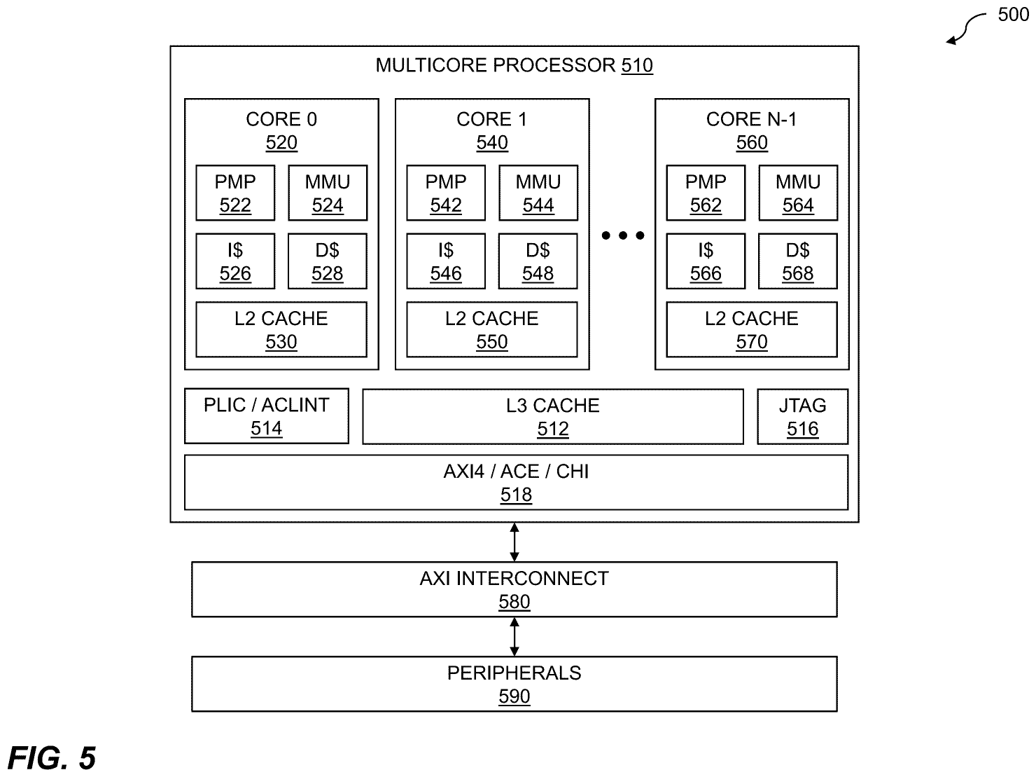

FIG. 5 is a block diagram illustrating a multicore processor. The processor, such as a RISC-V™ processor, ARM processor, or other suitable processor type, can include a variety of elements. The elements can include processor cores including multiprocessor cores, one or more caches, memory protection and management units, local storage, and so on. In embodiments, the processor core sequences vector operations for exception handling. The elements of the multicore processor can further include one or more of a private cache; a test interface such as a joint test action group (JTAG) test interface; one or more interfaces to a network such as a network-on-chip, shared memory and peripherals; and the like. The multicore processor is enabled by vector operation sequencing for exception handling. A processor core is accessed, wherein the processor core supports vector operations, wherein the processor core includes an execution pipeline, and wherein the execution pipeline is configured to execute micro-operations. A vector operation is issued, in the processor core, wherein the vector operation necessitates a plurality of execution cycles. The vector operation is split into a series of micro-operations. Execution of the series of micro-operations is initiated. The processor core receives an operation exception. The operation exception is processed. Execution of the series of micro-operations is completed, based on the timing of the operation exception.

In the block diagram 500, the multicore processor 510 can comprise two or more processors, where the two or more processors can include homogeneous processors, heterogeneous processors, etc. In the block diagram, the multicore processor can include N processor cores such as core 0 520, core 1 540, core N-1 560, and so on. Each processor can comprise one or more elements. In embodiments, each core, including cores 0 through core N-1 can include a physical memory protection (PMP) element, such as PMP 522 for core 0; PMP 542 for core 1, and PMP 562 for core N-1. In a processor architecture such as the RISC-V™ architecture, a PMP can enable processor firmware to specify one or more regions of physical memory such as cache memory of the shared memory, and to control permissions to access the regions of physical memory. The cores can include a memory management unit (MMU) such as MMU 524 for core 0, MMU 544 for core 1, and MMU 564 for core N-1. The memory management units can translate virtual addresses used by software running on the cores to physical memory addresses with caches, the shared memory system, etc.

The processor cores associated with the multicore processor 510 can include caches such as instruction caches and data caches. The caches, which can comprise level 1 (L1) caches, can include an amount of storage such as 16 KB, 32 KB, and so on. The caches can include an instruction cache I$ 526 and a data cache D$ 528 associated with core 0; an instruction cache I$ 546 and a data cache D$ 548 associated with core 1; and an instruction cache I$ 566 and a data cache D$ 568 associated with core N-1. In addition to the level 1 instruction and data caches, each core can include a level 2 (L2) cache. The level 2 caches can include L2 cache 530 associated with core 0; L2 cache 550 associated with core 1; and L2 cache 570 associated with core N-1. The cores associated with the multicore processor 510 can include further components or elements. The further elements can include a level 3 (L3) cache 512. The level 3 cache, which can be larger than the level 1 instruction and data caches, and the level 2caches associated with each core, can be shared among all of the cores. The further elements can be shared among the cores. In embodiments, the further elements can include a platform level interrupt controller (PLIC) 514. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 516. The JTAG can provide a boundary within the cores of the multicore processor. The JTAG can enable fault information to a high precision. The high-precision fault information can be critical to rapid fault detection and repair.

The multicore processor 510 can include one or more interface elements 518. The interface elements can support standard processor interfaces such as an Advanced extensible Interface (AXI™) such as AXI4™, an ARM™ Advanced extensible Interface (AXI™) Coherence Extensions (ACE™) interface, an Advanced Microcontroller Bus Architecture (AMBA™) Coherence Hub Interface (CHI™), etc. In the block diagram 500, the interface elements can be coupled to the interconnect. The interconnect can include a bus, a network, and so on. The interconnect can include an AXI™ interconnect 580. In embodiments, the network can include network-on-chip functionality. The AXI™ interconnect can be used to connect memory-mapped “master” or boss devices to one or more “slave” or worker devices. In the block diagram 500, the AXI interconnect can provide connectivity between the multicore processor 510 and one or more peripherals 590. The one or more peripherals can include storage devices, networking devices, and so on. The peripherals can enable communication using the AXI™ interconnect by supporting standards such as AMBA™ version 4, among other standards.

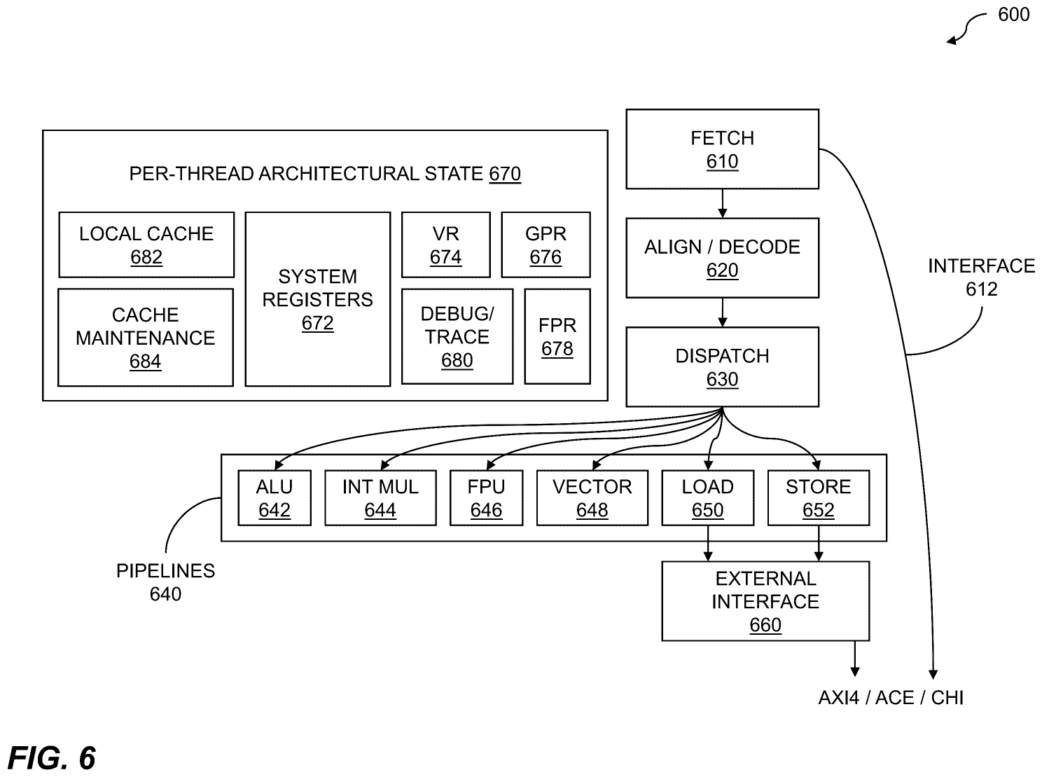

FIG. 6 is a block diagram for a pipeline. The use of one or more pipelines associated with a processor architecture can greatly enhance processing throughput. The processor architecture can be associated with one or more processor cores. The processing throughput can be increased because multiple operations can be executed in parallel. In embodiments, a processor core is accessed, where the processor core supports vector operations. The processor core enables vector operation sequencing for exception handling. A processor core is accessed, wherein the processor core supports vector operations, wherein the processor core includes an execution pipeline, and wherein the execution pipeline is configured to execute micro-operations. A vector operation is issued, in the processor core, wherein the vector operation necessitates a plurality of execution cycles. The vector operation is split into a series of micro-operations. Execution of the series of micro-operations is initiated. The processor core receives an operation exception. The operation exception is processed. Execution of the series of micro-operations is completed, based on the timing of the operation exception.

The blocks within the block diagram can be configurable in order to provide varying processing levels. The varying processing levels can be based on processing speed, bit lengths, numbers of micro-operations, and so on. The block diagram 600 can include a fetch block 610. The fetch block 610 can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 612. The interface can include a standard interface such as one or more industry standard interfaces. The interfaces can include an Advanced extensible Interface (AXI™), an ARM™ Advanced eXtensible Interface (AXI™) Coherence Extensions (ACE™) interface, an Advanced Microcontroller Bus Architecture (AMBA™) Coherence Hub Interface (CHI™), etc.

The block diagram 600 includes an align and decode block 620. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decoded packets. The decoded packets can be used in the pipeline to manage execution of operations. The block diagram 600 can include a dispatch block 630. The dispatch block can receive decoded instruction packets from the align and decode block. The decoded instruction packets can be used to control a pipeline 640, where the pipeline can include an in-order pipeline, an out-of-order (OoO) pipeline, etc. In embodiments, the processor core executes one or more instructions out of order. A pipeline can be associated with the one or more execution units. The pipelines associated with the execution units can include processor cores, arithmetic logic unit (ALU) pipelines 642, integer multiplier pipelines 644, floating-point unit (FPU) pipelines 646, vector unit (VU) pipelines 648, and so on. The dispatch unit can further dispatch instructions to pipelines that can include load pipelines 650, and store pipelines 652. The load pipelines and the store pipelines can access storage such as the common memory using an external interface 660. The external interface can be based on one or more interface standards such as the Advanced extensible Interface (AXI™). Following execution of the instructions, further instructions can update the register state. Other operations can be performed based on actions that can be associated with a particular architecture. The actions that can be performed can include executing instructions to update the system register state, trigger one or more exceptions, and so on.

In embodiments, the plurality of processors can be configured to support multi-threading. The system block diagram can include a per-thread architectural state block 670. The inclusion of the per-thread architectural state can be based on a configuration or architecture that can support multi-threading. In embodiments, thread selection logic can be included in the fetch and dispatch blocks discussed above. Further, when an architecture supports an out-of-order (OoO) pipeline, then a retire component (not shown) can also include thread selection logic. The per-thread architectural state can include system registers 672. The system registers can be associated with individual processors, a system comprising multiple processors, and so on. The system registers can include exception and interrupt components, counters, etc. The per-thread architectural state can include further registers such as vector registers (VR) 674. The vector registers can be grouped in a vector register file and can be used for vector operations. In embodiments, the width of the vector register file is 512 bits. Additional registers, such as general-purpose registers (GPR) 676 and floating-point registers (FPR) 678, can be included. These registers can be used for general purpose (e.g., integer) operations, and floating-point operations, respectively. The per-thread architectural state can include a debug and trace block 680. The debug and trace block can enable debug and trace operations to support code development, troubleshooting, and so on. In embodiments, an external debugger can communicate with a processor through a debugging interface such as a joint test action group (JTAG) interface. The per-thread architectural state can include a local cache state 682. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 684. The cache maintenance state can include maintenance needed, maintenance pending, and maintenance complete states, etc.

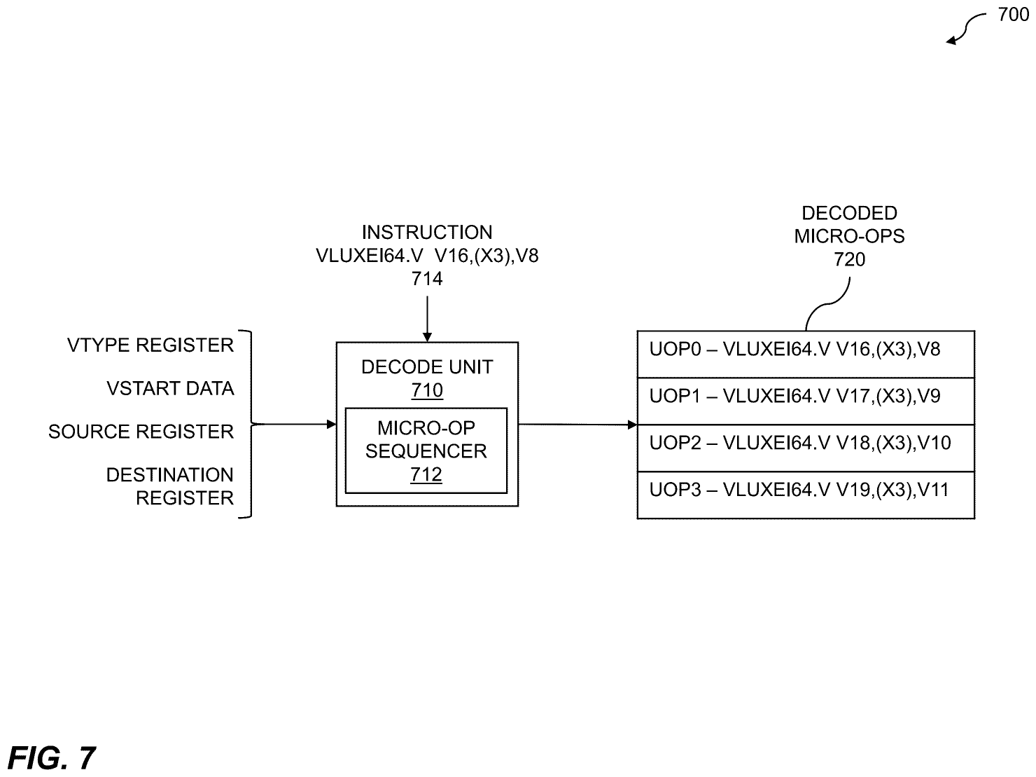

FIG. 7 shows a micro-operation example. Recall that a decode stage associated with a processor core can be used to split an operation such as a vector operation into a series of micro-operations. The micro-operations can include load operations and store operations associated with a vector operation. The micro-operations can be executed, where the execution can be accomplished on a processor core. The execution of the micro-operations can be interrupted due to an operation exception. The operation exception can be processed, and execution of the micro-operations can be completed. The micro-operations enable vector operation sequencing for exception handling. A processor core is accessed, wherein the processor core supports vector operations, wherein the processor core includes an execution pipeline, and wherein the execution pipeline is configured to execute micro-operations. A vector operation is issued, in the processor core, wherein the vector operation necessitates a plurality of execution cycles. The vector operation is split into a series of micro-operations. An operation exception is received by the processor core. The operation exception is processed. Execution of the series of micro-operations is completed, based on the timing of the operation exception.

The example 700 shows efficient decoding of a vector indexed load/store instruction. The decoding is accomplished using micro-operation sequencing. A decode unit 710 can be associated with a processor core (not shown). The decode unit can include a micro-operation sequencer 712. In embodiments, the micro-operation sequencer can assign the series of micro-operations, based on a type of the vector operation. A non-segmented vector indexed-unordered load operation is shown 714: vluxei64.v v (16), (x3), v8. LMU-4, VSEW=64 bits (from a VTYPE register), EEW=64 bits (from the opcode), VLEN=128 bits, and vl=8. In the example, LMUL is set to 4, VSEW=64 bit by executing a VSET instruction prior to above instruction. During the decode of “vluxci64.v v16, (x3), v8,” a micro-operation sequencer logic block will split the single instruction into four micro-operations 720. The micro-operation sequencer block 712 is implemented as a finite state machine, which takes inputs such as VTYPE register info (vsew, lmul), VSTART data, a source register (vrs2) and destination (vd) register. The micro-operation sequencer logic can ensure that it increments source (vrs2) and destination (vd) as per requirement of the processor vector spec when it breaks the instruction into four micro-operations. The processor vector spec can include a RISC-V vector spec.

An exception can occur. In the example, a page fault exception is reported during micro-operation uop3 execution. Once the LSU unit reports the exception with vstart value=6 to the decoder, the vstart value will be written to the start architectural register inside the decoder block during the retirement of uop2. After the exception is triggered, the program counter (PC) will start fetching from the exception handler. After servicing the exception, the PC should return to same instruction vluxei64.v v16, (x3), v8 to complete the entire load operation. Instead of starting the execution from micro-operation uop0, the decode logic will skip micro-operations uop0, uop1 and uop2, and only issue micro-operation uop3 as per the vstart architectural value. Based on the vector configurations, a particular instruction can be broken into a number of micro-operations, up to eight micro-operations. The above scheme can provide significant performance and power advantages during a variety of exception scenarios.

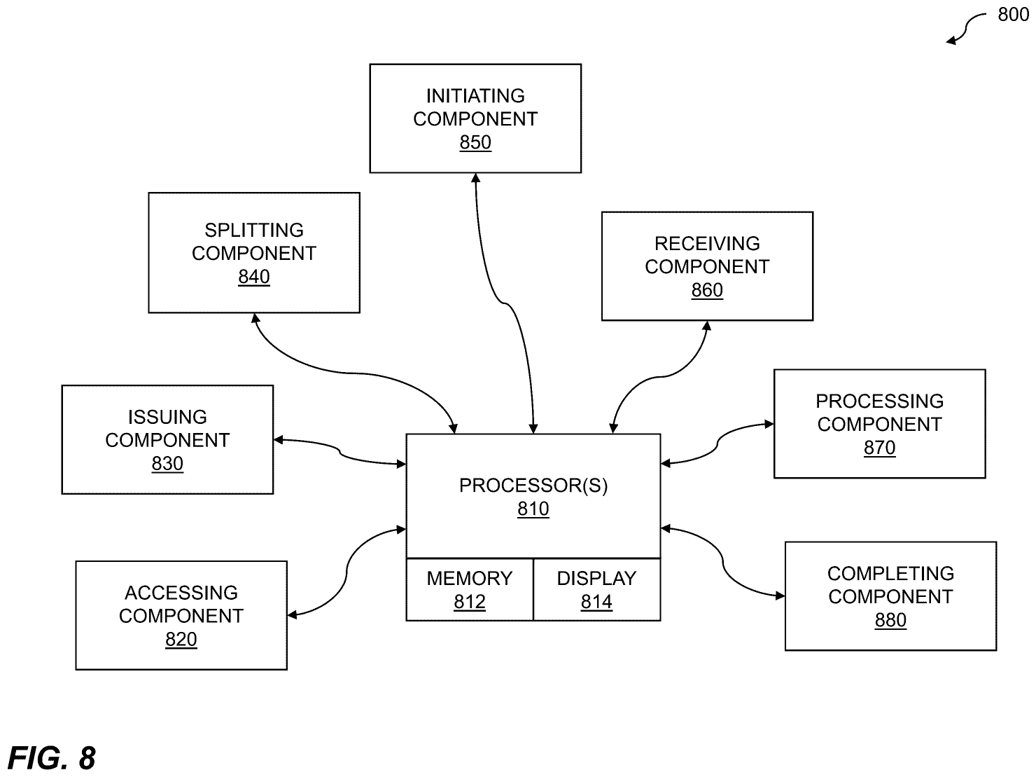

FIG. 8 is a system diagram for vector operation sequencing for exception handling. The system 800 can include instructions and/or functions for design and implementation of integrated circuits that support vector operation sequencing for exception handling. The system 800 can include instructions and/or functions for generation and/or manipulation of design data such as hardware description language (HDL) constructs for specifying structure and operation of an integrated circuit. The system 800 can further perform operations to generate and manipulate Register Level Transfer (RTL) abstractions. These abstractions can include parameterized inputs that enable specifying elements of a design such as a number of elements, sizes of various bit fields, and so on. The parameterized inputs can be input to a logic synthesis tool which in turn creates the semiconductor logic that includes the gate-level abstraction of the design that is used for fabrication of integrated circuit (IC) devices.

The system can include one or more of processors, memories, cache memories, displays, and so on. The system 800 can include one or more processors 810. The processors can include standalone processors within integrated circuits or chips, processor cores in FPGAs or ASICs, and so on. The one or more processors 810 are coupled to a memory 812, which stores operations. The memory can include one or more of local memory, cache memory, system memory, etc. The system 800 can further include a display 814 coupled to the one or more processors 810. The display 814 can be used for displaying data, instructions, operations, and the like. The operations can include instructions and functions for implementation of integrated circuits, including processor cores. In embodiments, the processor cores can include RISC-V™ processor cores. A system comprising the one or more processors 810, when executing the instructions which are stored in the memory 812, are configured to: access a processor core, wherein the processor core supports vector operations, wherein the processor core includes an execution pipeline, and wherein the execution pipeline is configured to execute micro-operations; issue a vector operation, in the processor core, wherein the vector operation necessitates a plurality of execution cycles; split the vector operation into a series of micro-operations; initiate execution of the series of micro-operations; receive, by the processor core, an operation exception; process the operation exception; and complete execution of the series of micro-operations, based on the timing of the operation exception.

The system 800 can include an accessing component 820. The accessing component 820 can include functions and instructions for accessing a processor core. The processor core can include an ARM core, a MIPS core, and/or other suitable core type. In embodiments, the processor core can include a RISC-V architecture. The processor core supports vector operations. The RISC-V architecture can include extensions, where the extensions can enable execution of various arithmetic and logic operations. In embodiments, RISC-V architecture can include vector extensions. The vector extensions can include a plurality of vector extensions. In embodiments, the vector extensions can include ELEN, VLEN, SEW, LMUL, VLMAX, VL, and VSTART components. The processor core includes an execution pipeline, where the execution pipeline is configured to execute micro-operations. The micro-operations can include accessing a vector register, a starting address for data, a source register, a destination register, and so on.

The system 800 can include an issuing component 830. The issuing component 830 can include functions and instructions for issuing a vector operation, in the processor core, wherein the vector operation necessitates a plurality of execution cycles. The plurality of execution cycles can be associated with reading or loading data, executing operations such as vector operations on the data, writing or storing data, and so on. In embodiments, the vector operation can include a vector indexed load/store instruction. The system 800 can include a splitting component 840. The splitting component 840 can include functions and instructions for splitting the vector operation into a series of micro-operations. The series of micro-operations can be generated by a decode stage associated with the processor core. The micro-instructions generated by the decode stage can depend on the type of vector operation. The system 800 can include an initiating component 850. The initiating component 850 can include functions and instructions for initiating execution of the series of micro-operations. The execution of the micro-operations can be accomplished using one or more processors associated with the processor core. The system 800 can include a receiving component 860. The receiving component 860 can include functions and instructions for receiving, by the processor core, an operation exception. An operation exception can be associated with a memory access exception, a runtime error, a higher priority operation or process, and so on. An exception can be indicated by a flag, a semaphore, a code such as an error code, and the like. In embodiments, the operation exception can occur on a program counter basis. The system 800 includes a processing component 870. The processing component 870 can include functions and instructions for processing the operation exception. The processing the exception can be accomplished using an exception handler, where the exception handler can be associated with the processor core. The exception handler can attempt to resolve the cause of the exception, such as a memory access conflict, an illegal operation, etc.

The system 800 can include a completing component 880. The completing component 880 can include functions and instructions for completing execution of the series of micro-operations, based on the timing of the operation exception. The execution of the series of micro-operations can be accomplished by resuming execution of the micro-operations from where the exception occurred. In embodiments, the splitting, the initiating, and the completing can be performed by a micro-operation sequencer within a decode unit of the processor core. The splitting, the initiating, and the completing can be accomplished using a variety of techniques. In embodiments, the splitting, the initiating, and the completing can be accomplished by an independent state machine within the processor core. The micro-operation sequencer can sequence the micro-operations based on the vector operation that is being executed. In embodiments, the micro-operation sequencer can assign the series of micro-operations, based on a type of the vector operation. The micro-operation sequencer can track other aspects of the executing the micro-operations. In embodiments, the micro-operation sequencer can track execution of the series of micro-operations. The tracking can include tracking which micro-operations have been executed, which micro-operation is executing, and which micro-operations have yet to be executed. In embodiments, the micro-operation sequencer can save the last successfully completed micro-operation, based on the operation exception being received. The exception can be handled, and operation can return to execution of the micro-operations. In embodiments, the micro-operation sequencer can restart the series of micro-operations at the first unexecuted micro-operation of the series of micro-operations, based on completion of the operation exception. The execution of the micro-operations can continue until the series of micro-operations has been executed.

The system 800 can include a computer program product embodied in a non-transitory computer readable medium for instruction execution, the computer program product comprising code which causes one or more processors to generate semiconductor logic for: accessing a processor core, wherein the processor core supports vector operations, wherein the processor core includes an execution pipeline, and wherein the execution pipeline is configured to execute micro-operations; issuing a vector operation, in the processor core, wherein the vector operation necessitates a plurality of execution cycles; splitting the vector operation into a series of micro-operations; initiating execution of the series of micro-operations; receiving, by the processor core, an operation exception; processing the operation exception; and completing execution of the series of micro-operations, based on the timing of the operation exception.

The system 800 can include a computer system for instruction execution comprising: a memory which stores instructions; one or more processors attached to the memory wherein the one or more processors, when executing the instructions which are stored, are configured to: access a processor core, wherein the processor core supports vector operations, wherein the processor core includes an execution pipeline, and wherein the execution pipeline is configured to execute micro-operations; issue a vector operation, in the processor core, wherein the vector operation necessitates a plurality of execution cycles; split the vector operation into a series of micro-operations; initiate execution of the series of micro-operations; receive, by the processor core, an operation exception; process the operation exception; and complete execution of the series of micro-operations, based on timing of the operation exception.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for instruction execution comprising:
accessing a processor core, wherein the processor core supports vector operations, wherein the processor core includes an execution pipeline, and wherein the execution pipeline is configured to execute micro-operations;
issuing a vector operation, in the processor core, wherein the vector operation necessitates a plurality of execution cycles;
splitting the vector operation into a series of micro-operations;
initiating execution of the series of micro-operations;
receiving, by the processor core, an operation exception;
processing the operation exception; and
completing execution of the series of micro-operations, based on timing of the operation exception.

2. The method of claim 1 wherein the splitting, the initiating, and the completing are performed by a micro-operation sequencer within a decode unit of the processor core.

3. The method of claim 2 wherein the micro-operation sequencer assigns the series of micro-operations, based on a type of the vector operation.

4. The method of claim 3 wherein the micro-operation sequencer tracks execution of the series of micro-operations.

5. The method of claim 4 wherein the micro-operation sequencer saves the last successfully completed micro-operation, based on the operation exception being received.

6. The method of claim 5 wherein the micro-operation sequencer restarts the series of micro-operations at a first unexecuted micro-operation of the series of micro-operations, based on completion of the operation exception.

7. The method of claim 2 wherein the micro-operation sequencer increments source and destination arguments for each of the micro-operations within the series of micro-operations.

8. The method of claim 2 wherein the micro-operation sequencer appends a sequence ID to each of the series of micro-operations.

9. The method of claim 8 wherein the sequence ID enables tracking operational flow among pipeline stages of the execution pipeline of the processor core.

10. The method of claim 1 wherein the operation exception occurs on a program counter basis.

11. The method of claim 10 wherein the series of micro-operations occurs within a single program counter step.

12. The method of claim 10 wherein the series of micro-operations occurs over a plurality of processor core clock cycles.

13. The method of claim 1 wherein the timing of the operation exception occurs at an indeterminate point within the execution of the series of micro-operations.

14. The method of claim 1 wherein the splitting, the initiating, and the completing are accomplished by an independent state machine within the processor core.

15. The method of claim 1 wherein the completing includes restarting the micro-operations, based on retirement of a successfully completed micro-operation within the series of micro-operations.

16. The method of claim 15 wherein the retirement of a successfully completed micro-operation within the series of micro-operations occurs prior to the operation exception.

17. The method of claim 16 wherein the operation exception initiates writing a restart value to an architectural register within a decoder block of the processor core.

18. The method of claim 17 wherein the architectural register within the decoder block of the processor core comprises a VSTART architectural register.

19. The method of claim 1 wherein the vector operation comprises a vector indexed load/store instruction.

20. The method of claim 1 wherein the processor core comprises a RISC-V architecture that includes vector extensions.

21. The method of claim 20 wherein the vector extensions include ELEN, VLEN, SEW, LMUL, VLMAX, VL, and VSTART components.

22. A computer program product embodied in a non-transitory computer readable medium for instruction execution, the computer program product comprising code which causes one or more processors to generate semiconductor logic for:
accessing a processor core, wherein the processor core supports vector operations, wherein the processor core includes an execution pipeline, and wherein the execution pipeline is configured to execute micro-operations;
issuing a vector operation, in the processor core, wherein the vector operation necessitates a plurality of execution cycles;
splitting the vector operation into a series of micro-operations;
initiating execution of the series of micro-operations;
receiving, by the processor core, an operation exception;
processing the operation exception; and
completing execution of the series of micro-operations, based on timing of the operation exception.

23. A computer system for instruction execution comprising:
a memory which stores instructions;
one or more processors coupled to the memory wherein the one or more processors, when executing the instructions which are stored, are configured to:
access a processor core, wherein the processor core supports vector operations, wherein the processor core includes an execution pipeline, and wherein the execution pipeline is configured to execute micro-operations;
issue a vector operation, in the processor core, wherein the vector operation necessitates a plurality of execution cycles;
split the vector operation into a series of micro-operations;
initiate execution of the series of micro-operations;
receive, by the processor core, an operation exception;
process the operation exception; and
complete execution of the series of micro-operations, based on timing of the operation exception.
